(19) United States
(12) Patent Application Publication
(10) Pub. No.: US 2011/0272623 A1
(43) Pub. Date: Nov. 10, 2011

(54) FORMULATION OF HYDROPHOBIZED MAGNETITE

(75) Inventors: Imme DOMKE, Mannheim (DE); Wolfgang ROHDE, Speyer (DE); Daniel Schäfer, Bobenheim-Roxheim (DE); Alexej MICHAILOVSKI, Ludwigshafen (DE); Jürgen OSWALD, Frankenthal (DE); Reinhold RIEGER, Offstein (DE); Piyada CHAROENSIRISOMBOON, Mannheim (DE); Florian STRICKER, Freiburg (DE); Alexander WALLON, Mannheim (DE); Jenny REUBER, Mannheim (DE); Jan-Dirk ARNDT, Mannheim (DE)

(73) Assignees: Siemens AG, Muenchen (DE); BASF SE, Ludwigshafen (DE)

(21) Appl. No.: 13/101,372

(22) Filed: May 5, 2011

Related U.S. Application Data
(60) Provisional application No. 61/331,843, filed on May 6, 2010.

(51) Int. Cl. H01F 1/01; B03C 1/02; C09D 1/00

(52) U.S. Cl. 252/62.56; 106/287.16; 106/287.29; 210/695

(57) ABSTRACT

The present invention relates to a dispersion at least comprising particles comprising at least one magnetic iron oxide as component A and a solvent mixture as component B comprising (B1) 5% to 95% by weight of at least one water-miscible organic solvent LM as component B1 and (B2) 5% to 95% by weight of water as component B2, the sum of components B1 and B2 making 100% by weight, and to a method for producing a dispersion of this kind, comprising at least the steps (I) mixing particles comprising at least one magnetic iron oxide with at least one water-miscible organic solvent LM and water, (II) homogenizing the mixture from step (I), where a shearing energy of at least 2 kW/m³ is introduced into the mixture in step (II).

The present invention relates to a dispersion at least comprising particles comprising at least one magnetic iron oxide as component A and a solvent mixture as component B comprising 5% to 95% by weight of at least one water-miscible organic solvent LM as component B1 and 5% to 95% by weight of water as component B2, the sum of components B1 and B2 making 100% by weight, and to a method for producing a dispersion of this kind, comprising at least the steps (I) mixing particles comprising at least one magnetic iron oxide with at least one water-miscible organic solvent LM and water, (II) homogenizing the mixture from step (I), where a shearing energy of at least 2 kW/m³ is introduced into the mixture in step (II), to the use of a dispersion of this kind in the magnetic separation of mixtures or for producing paint formulations, and to a paint formulation comprising such a dispersion.

Stable dispersions of magnetic particles in water and methods for producing them are already known from the prior art.

M. T. Lopez-Lopez et al., Journal of Colloids and Interface Science, 291 (2005), 144 to 151, disclose an investigation into the stability of magnetic particles in various nonpolar carrier liquids. The magnetic particles according to this document are surface-modified with oleic acid. Nonpolar solvents cited in this document include kerosene, mineral oil, dodecane, carbon tetrachloride, chloroform, methylene chloride, and, as a comparative therewith, water. Mixtures of water with organic solvents that are miscible with water are not specified in this document.

F. Yan et al., J. Nanopart. Res. (2009) 11 :289 to 296, disclose composite magnetite-polystyrene particles which can be produced from oleic acid-modified magnetite nanoparticles by miniemulsion polymerization. For that purpose, magnetite nanoparticles are surface-modified with oleic acid and dispersed in a solution of styrene and cyclohexane. Then a solution of sodium dodecyl sulfate and sodium bicarbonate in water is added in order to form an aqueous phase. Using ultrasound, a miniemulsion is prepared, and the polymerization is initiated by means of a free-radical initiator.

P. Somasundaran et al. in Proceedings of the International Symposium on fine particles processing, Las Vegas, Nev., Feb. 24-28, 1980, pages 1310 to 1324 disclose the production of magnetic liquids in polar solvents. This is achieved by treating magnetite particles with surface-active substances such as dodecylbenzenesulfonate, sodium oleate or various kinds of poly(oxyethylene) nonylphenyl ethers and dispersing them in water.

WO 2009/151148 A1 discloses composite particles, a method for producing them, and dispersions comprising these composite particles. The composite particles are produced by mixing a first liquid with particles to give a mixture. This mixture is then mixed with a second liquid in order to give an emulsion comprising a dispersed form of the first liquid and of the particles; the emulsion is then mixed with a polymeric compound, and the first liquid is removed from the emulsion by fractional distillation. The first liquid may be an organic liquid which is insoluble in the second liquid. The second liquid may be water or an aqueous solution. Examples of the first liquid, according to WO 2009/151148 A1, are hydrocarbon solvents such as hexane, heptane or octane, aromatic hydrocarbon solvents such as benzene, toluene or xylene, halogenated hydrocarbons such as dichloromethane, chloroform, chloroethane or dichloroethane, ethers such as ethyl ether, diethyl ether, and isobutyl ether, esters or ketones. These stated solvents are by definition, according to WO 2009/151148 A1,not miscible with water.

An object of the present invention relative to the prior art is to provide a dispersion of magnetic particles which is distinguished by very highly homogeneous distribution of the magnetic particles in this dispersion and, consequently, by particularly good accessibility to the hydrophobic surface of the particles. This surface accessibility is important particularly in the context of magnetically assisted ore separation, in order to ensure the docking of the hydrophobic ores of value with the surface of magnetic particles, such as magnetite particles, for example. Furthermore, good accessibility is to be ensured because, when a dispersion of this kind is used in paints, for example, optimum adhesion of the particles to the substrate can be ensured only if the surface is freely accessible. A further intention is to provide a method for producing this magnetic dispersion that is notable for producing a corresponding dispersion having the advantages specified above. The magnetic dispersions of the invention are to be useful for the separation of mixtures or for the production of paint formulations.

These objects are achieved by means of a dispersion at least comprising:
(A) particles comprising at least one magnetic iron oxide as component A and
(B) a solvent mixture as component B, comprising
   (B1) 5% to 95% by weight of at least one water-miscible organic solvent LM as component B1 and
   (B2) 5% to 95% by weight of water as component B2, the sum of components B1 and B2 making 100% by weight.

The objects are further achieved by means of the method of the invention for producing a dispersion of the invention, comprising at least the following steps:
(I) mixing particles comprising at least one magnetic iron oxide with at least one water-miscible organic solvent LM and water, and
(II) homogenizing the mixture from step (I),
   wherein a shearing energy of at least 2 kW/m³ is introduced into the mixture in step (II), and also by means of the use of these dispersions in the magnetic separation of compositions or for the production of paint formulations, and also by means of paint formulations comprising such a dispersion.

The dispersion of the invention comprises at least:
(A) particles comprising at least one magnetic iron oxide as component A and
(B) a solvent mixture as component B, comprising
   (B1) 5% to 95% by weight of at least one water-miscible organic solvent LM as component B1 and
   (B2) 5% to 95% by weight of water as component B2, the sum of components B1 and B2 making 100% by weight.

### Component (A):

As component A, the dispersion of the invention comprises particles which comprise at least one magnetic iron oxide. The particles used as component A in accordance with the invention may, in the context of the present invention, comprise not only the magnetic iron oxide but also further substances or mixtures of substances, examples being other oxides of metals of the main groups and/or transition groups of the Periodic Table of the Elements—for example, the dispersion may also comprise Co-doped iron oxides.

In one preferred embodiment, other than the magnetic iron oxides, there are no further substances or mixtures of substances present in the particles used as component A in accordance with the invention. In an especially preferred embodiment, the particles used as component A are composed of magnetic iron oxide or of a mixture of two or more magnetic iron oxides.

Magnetic iron oxides are known per se to the skilled person. They are obtainable either from natural occurrence or through production methods with which the skilled person is familiar.

In one preferred embodiment of the dispersion of the invention, the particles present as component A comprise at least one iron oxide selected from the group consisting of magnetite, maghemite, and mixtures thereof. In one particularly preferred embodiment, the particles present as component A are composed of magnetite, maghemite or a mixture thereof.

The present invention accordingly also provides the dispersion of the invention where the particles present as component A comprise at least one iron oxide selected from the group consisting of magnetite, maghemite, and mixtures thereof.

Magnetite has the general chemical formula Fe₃O₄, which can be formulated more precisely as Fe(II)Fe(III)₂O₄.

Maghemite has the general chemical formula Fe₂O₃.

Magnetite and maghemite are obtained from natural occurrence. The particle size here may be adjusted substantially by milling, a method which produces particles with diameters of more than 1 μm. Synthetically, magnetite and maghemite may be prepared from the precipitation of the corresponding metal salts (described in U.S. Pat. No. 4,469,669 A, for example), in which case the size of the particles may be adjusted accordingly through precise monitoring of the reaction conditions. Here, typically, substantially smaller particles are obtained, with a diameter, for example, of 0.5 nm to 20 μm.

The particles used as component A in accordance with the invention may per se have any diameter known to be suitable to the skilled person. In one preferred embodiment, the particles comprising at least one magnetic iron oxide have a diameter of 200 nm to 100 μm, more preferably 500 nm to 100 μm, very preferably 1 μm to 20 μm. In the case of asymmetric particles, the diameter refers to the largest distance present in the particle. In the particle size distribution of the metal oxide in the dispersion, there may also be bimodality or multimodality, with different fractions of magnetic oxide particles being unified.

The present invention therefore preferably provides the dispersion of the invention where the particles comprising at least one magnetic iron oxide have a diameter of 200 nm to 100 μm.

Generally speaking, the particles present in accordance with the invention may have any possible symmetric or asymmetric form, being, for example, spherical, ellipsoidal, cylindrical, cuboidal, cubic, or in any other forms. Since the particles used in accordance with the invention are obtained preferably by milling from larger particles, the particles are preferably not symmetrical but rather asymmetric in form.

The particles present as component A in the dispersion may optionally be modified on the surface with at least one surface-active substance.

The present invention therefore preferably provides the dispersion of the invention where the particles comprising at least one magnetic iron oxide (A) are modified on the surface with at least one surface-active substance.

For the modification of the particles it is possible in general to use all substances which appear to be suitable to the skilled person. In one preferred embodiment the particle is hydrophobized on the surface with at least one hydrophobic compound.

The hydrophobic compound is generally selected from compounds of the general formula (I)

B—Y (I),

in which
B is selected from linear or branched C₃-C₁₀₀ alkyl, C₃-C₁₀₀ heteroalkyl, optionally substituted C₆-C₁₀₀ aryl, optionally substituted C₆-C₁₀₀ heteroaryl, and C₆-C₃₀ aralkyl, and
Y is a group with which the compound of the general formula (I) attaches to the at least one magnetic particle.

In one particularly preferred embodiment, B is a linear or branched C₆-C₁₈ alkyl, preferably linear C₈-C₁₂ alkyl, very preferably a linear C₁₂ alkyl. Heteroatoms optionally present in accordance with the invention are selected from N, O, P, and S and halogens such as F, Cl, Br, and I.

In another particularly preferred embodiment, Y is selected from the group consisting of —(X)ₙ—SiHHal₃, —(X)ₙ—SiHHal₂, and —(X)ₙ—SiH₂Hal, where Hal is F, Cl, Br, I, and from anionic groups such as —(X)ₙ—SiO₃³⁻, —(X)ₙ—CO₂⁻, —(X)ₙ—PO₃²⁻, —(X)ₙ—PO₂S²⁻, —(X)ₙ—POS₂²⁻, —(X)ₙ—PS₃²⁻, —(X)ₙ—PS₂⁻, —(X)ₙ—POS₋, —(X)ₙ—PO₂⁻, —(X)ₙ—CO₂ ⁻, —(X)ₙ—CS₂⁻, —(X)ₙ—COS⁻, —(X)ₙ—C(S)NHOH, and —(X)ₙ—S⁻, where X is O, S, NH, CH₂, and n is 0, 1 or 2, and optionally cations selected from the group consisting of hydrogen, NR₄⁺, where R independently at each occurrence is hydrogen and/or C₁-C₈-alkyl, alkali metals, alkaline earth metals or zinc, and also —(X)ₙ—Si(OZ)₃, where n is 0, 1 or 2 and Z is a charge, hydrogen or a short-chain alkyl radical.

Especially preferred hydrophobizing substances of the general formula (I) are alkoxysilanes, alkylphosphonic acids or alkyl phosphates, carboxylic acids or mixtures thereof. The alkyl radical preferably has 3 to 12 C atoms, which may be either branched or linear. The octyl radical is very preferred.

In accordance with the invention, the amount of surface-active substance optionally present on the particles is dependent, for example, on the nature and size of the particles used, and also on the nature of the hydrophobizing substance used, of the general formula (I). The amount may be determined readily by the skilled person and is, for example, 1 to 50 molecules of hydrophobizing substance per nm² of particle surface area.

In the dispersion of the invention, in general, component A is present in a suitable amount to give a dispersion which is suitable for the envisaged requirement, as for example in the magnetic separation of mixtures or in paint formulations.

In one preferred embodiment, component A is present in the dispersion of the invention in an amount of 1% to 95% by weight, preferably 40% to 90% by weight, more preferably 70% to 90% by weight, for example, 80% by weight, based in each case on the total dispersion.

### Component (B):

The dispersion of the invention comprises as component B a solvent mixture comprising:
(B1) 5% to 95% by weight of at least one water-miscible organic solvent LM as component B1, and
(B2) 5% to 95% by weight of water as component B2,
   where the sum of components B1 and B2 makes 100% by weight.

### Component (B1):

As component B1 there is at least one water-miscible organic solvent LM. In the mixture according to the invention, this solvent LM functions as a dispersing assistant—in other words, by means of this solvent LM in the dispersion of the invention, the particles to be dispersed are successfully distributed homogeneously in the dispersion medium. Furthermore, component B1 contributes to the production of a stable dispersion—in other words, even after prolonged storage, there is no sedimentation of the dispersed particles.

As component B1 it is possible in general to use any water-miscible organic solvent that is known to the skilled person.

In the context of the present invention, “water-miscible” means that component B1 is miscible in any proportion with water, forming a uniform phase, and the formation of two or more phases does not occur.

In one preferred embodiment, the water-miscible organic solvent LM is selected from the group consisting of monohydric alcohols, such as methanol, ethanol, propanols such as n-propanol, isopropanol, butanols such as n-butanol, isobutanol, and tert-butanol, polyhydric alcohols, such as ethylene glycol, ethers, polyethers, and mixtures thereof.

The present invention therefore preferably provides the dispersion of the invention where the water-miscible organic solvent LM is selected from the group consisting of monohydric alcohols, polyhydric alcohols, ethers, polyethers, and mixtures thereof.

Present as component B2 in the solvent mixture used in accordance with the invention is water.

In the context of the present invention it is possible to use either pure water, i.e., demineralized and/or deionized water, or conventional mains water, comprising typical fractions of salts and minerals. It is likewise possible to use process water from mining companies, which comprises a typical mineral concentration of around 0.07 g/100 g sulfate, 0.02 g/100 g nitrate, 0.02 g/100 g chloride, 600 mg of sodium, and 10 mg of iron, in each case per 100 g.

In the component B present in accordance with the invention, component B1 is present generally in an amount of 5% to 95% by weight, preferably 60% to 90% by weight, more preferably 70% to 85% by weight, for example, 80% by weight, and component B2 is present generally in an amount of 5% to 95% by weight, preferably 10% to 40% by weight, more preferably 15% to 30% by weight, for example, 20% by weight, the sum of components B1 and B2 making 100% by weight. This means that the amount figures for components B1 and B2 are based on the solvent mixture B, but not on the dispersion as a whole.

Component B in the dispersion of the invention is present in an amount of preferably 5% to 99% by weight, preferably 10% to 60% by weight, more preferably 10% to 30%, for example, 20% by weight.

The sum of components A and B makes in each case 100% by weight, which means that the amount figures for components A and B are based on the dispersion as a whole.

In one preferred embodiment, component A is present in the dispersion of the invention in an amount of 1% to 95% by weight and component B is present in an amount of 5% to 99% by weight; with particular preference, component A is present in an amount of 40% to 90% by weight and component B in an amount of 10% to 60% by weight; with very particular preference, component A is present in an amount of 70% to 90% by weight and component B in an amount of 10% to 30% by weight, based in each case on the dispersion as a whole, where the sum of components A and B adds up in each case to 100% by weight. For example, component A is present at 80% by weight and component B at 20% by weight in the dispersion according to the invention.

In one preferred embodiment the present invention provides the dispersion of the invention where components (A), (B), (B1), and (B2) are present in the following amounts:
(A) 1% to 95% by weight of particles comprising at least one magnetic iron oxide as component A,
(B) 5% to 99% by weight of at least one solvent mixture as components B, comprising
   (B1) 5% to 95% by weight of at least one water-miscible organic solvent LM as component B1 and
   (B2) 5% to 95% by weight of water, the sum of components (B1) and (B2) making 100% by weight,
      and the sum of components (A) and (B) making 100% by weight.

In one preferred embodiment, in the dispersion according to the invention, there are only components A and B comprising the components B1 and B2. It is also possible in accordance with the invention for there to be further adjuvants present in addition to components A and B, examples being other finely divided oxides.

The present invention also provides a method for producing a dispersion according to the invention, comprising at least the following steps:
(i) mixing particles comprising at least one magnetic iron oxide as component A with at least one water-miscible organic solvent LM as component B1 and water as component B2, and
(II) homogenizing the mixture from step (I),
   where a shearing energy of at least 2 kW/m³ is introduced into the mixture in step (II).

Suitable and preferred components A, B, B1, and B2, and also corresponding suitable and preferred amounts, have already been specified for the dispersion, and apply accordingly for the method of the invention.

### Step (I):

Step (I) of the method of the invention comprises the mixing of particles comprising at least one magnetic iron oxide (component A) with at least one water-miscible organic solvent LM (component B1) and water (component B2).

The mixing of the invention according to step (I) may take place in general by all of the techniques that are known to the skilled person, as for example by combining the individual components and mixing them with suitable apparatus. On the laboratory scale, this step may take place with a paddle stirrer or an anchor stirrer. On the industrial scale, this step may also take place via a Mischsirene mixer or via the premixing of solid and liquid in accordance with the prior art, with subsequent in-line dispersing.

It is possible in accordance with the invention to introduce a high shearing energy into the mixture additionally in the course of the mixing in step (I) of the method of the invention. This shearing energy amounts, for example, to at least 2 kW/m³, preferably at least 50 kW/m³, more preferably at least 500 kW/m³. In one preferred embodiment, a shear rate of at least 2000 1/s, preferably at least 5000 1/s, more preferably at least 10000 1/s, is generated.

It is therefore possible in accordance with the invention for the high shearing energy of the invention to be introduced both in the mixing of the components and also in the subsequent homogenizing of the mixture.

The inventive interaction of components A, B1, and B2 present in the dispersion, more particularly component B1, and the high shearing energy used in producing it has the effect that a dispersion is obtained which has particularly advantageous properties in respect of homogeneity and stability.

Step (I) of the method of the invention is carried out generally at a temperature of 1 to 80° C., preferably at 20 to 40° C., more preferably ambient temperature.

The operation of mixing the components together may take place in general in various ways.

In one preferred embodiment of the method of the invention, in step (I), firstly particles are introduced and subsequently a mixture comprising at least one water-miscible organic solvent and water is added.

In this embodiment, the particles are introduced and a mixture prepared beforehand and comprising the components B1 and B2 is added to the particles.

The mixture of water-miscible organic solvent and water may be prepared by all of the techniques that are known to the skilled person, as for example by simply combining the two components in suitable stirring containers, mixing pumps or injectors.

In another preferred embodiment of the method of the invention, in step (I), first the particles are introduced, then a water-miscible organic solvent is added, and subsequently water is added.

In this embodiment, again, the particles to be dispersed are introduced first. Subsequently a water-miscible organic solvent is added. The mixture comprising particles and water-miscible organic solvent is then preferably stirred, in the course of which the aforementioned high shearing energy may be introduced. It is also possible in accordance with the invention, however, for a lower shearing energy to be introduced in this step of the method.

The mixture comprising particles and water-miscible organic solvent is then admixed in a further step with water. In this step as well, the aforementioned high shearing energy may be introduced. In accordance with the invention, however, it is also possible for a lower shearing energy to be introduced in this step of the method. In a further preferred embodiment of the method of the invention, in step (I), first the particles are introduced, then water is added, and subsequently a water-miscible organic solvent is added.

In this embodiment, again, the particles to be dispersed are introduced first. Subsequently water is added. The mixture comprising particles and water is then preferably stirred, in the course of which the aforementioned high shearing energy can be introduced. It is also possible in accordance with the invention, however, for a lower shearing energy to be introduced in this step of the method.

The mixture comprising particles and water is then admixed in a further step with a water-miscible organic solvent. In this step as well, the aforementioned high shearing energy may be introduced. It is also possible in accordance with the invention, however, for a lower shearing energy to be introduced in this step of the method.

The three stated preferred embodiments of step (I) of the method of the invention may also in each case be carried out such that water, a water-miscible organic solvent or a mixture thereof is introduced, and the particles are added to the liquid constituents. It is also possible, for example, first to introduce a liquid constituent, such as water and/or a water-miscible organic solvent, and to add the particles. Optionally the second liquid component is added subsequently.

At each addition of particles or liquid components, they may in each case be added as the total amount, in one portion, or in two or more smaller portions.

Where the particles comprising at least one magnetic iron oxide are treated with a surface-active substance, this surface-active substance is, in one preferred embodiment, applied to the surface of the particles before the dispersion is prepared in accordance with the method of the invention.

The present invention therefore preferably provides the method of the invention where the particles are treated before step (I) with at least one surface-active substance.

The optional treatment, in accordance with the invention, of the particles with at least one surface-active substance may take place in general by all of the techniques that are known to the skilled person. The treatment may be carried out in bulk or in dispersion, preferably in suspension, more preferably in aqueous suspension.

In one embodiment of the method of the invention, the treatment is carried out with at least one surface-active substance in bulk, i.e., in the absence of a dispersion medium.

For example, the particles to be treated and the at least one surface-active substance are combined without further dispersion medium, in the corresponding amounts, and are mixed. Suitable mixing apparatus is known to the skilled person, examples being mills, such as a ballmill.

In another possible embodiment, the treatment is carried out in a dispersion, preferably in suspension. Suitable dispersion media are selected, for example, from the group consisting of water, water-soluble organic compounds, such as alcohols having 1 to 4 carbon atoms, and mixtures thereof, more preferably water.

The treatment of the particles is carried out in general at a temperature of 1 to 80° C., preferably at 20 to 40° C., more preferably at ambient temperature.

After the particles have been treated with at least one surface-active substance, any dispersion medium present may be removed, by means, for example, of filtration, decanting, centrifuging, etc.

In accordance with the invention it is also possible, however, for the surface-treated particles to remain in dispersion and for the as yet absent component B1 or B2 to be added to this dispersion.

### Step (II):

Step (II) of the method of the invention comprises the homogenizing of the mixture from step (I), and in step (II) a shearing energy of at least 2 kW/m³ is introduced into the mixture.

Irrespective of whether a correspondingly high shearing energy has been introduced into the mixture during the preparation of the mixture in accordance with step (I), the mixture obtained is homogenized in step (II) of the invention in order, for example, to obtain particularly high homogeneity of the dispersion.

The shearing energy introduced in step (II) of the method of the invention is generally at least 2 kW/m³, preferably at least 10 kW/m³, more preferably at least 50 kW/m³, very preferably at least 500 kW/m³.

In step (II) of the method of the invention, in one preferred embodiment, a shear rate of at least 2000 1/s, preferably at least 5000 1/s, more preferably at least 10000 1/s, is generated.

The high shearing energy or shear rate introduced preferably in accordance with the invention may in accordance with the invention be obtained by means, for example, of a high stirrer speed.

In accordance with the invention it is possible for steps (I) and (II) to be separated from one another in terms of time—in other words, step (I) is carried out first, and subsequently the homogenization takes place in accordance with step (II). In accordance with the invention, however, it is also possible for the two steps to be carried out simultaneously or without separation from one another—in other words, with introduction of a correspondingly high shearing energy in the course of the mixing in step (I). It is also possible, in accordance with the invention, for a correspondingly high shearing energy to be introduced both in step (I) and in step (II).

Step (II) of the method of the invention may be carried out in general in all of the apparatus that is known to the skilled person and appears to be suitable—for example, in a stirrer reactor. The high shearing energy according to the invention is introduced, for example, by apparatus known to the skilled person, such as sonotrodes, Turrax devices, agitator mills, kneading devices or intensive mixers. In one preferred embodiment, steps (I) and (II) are carried out in the same apparatus.

After step (II) of the method of the invention, the dispersion according to the invention is obtained, which on account of the components present and the specific mode of production in accordance with the invention is characterized by particularly high homogeneity, which ensures a maximum surface area of the dispersed magnetic oxide particles.

Step (II) may be followed, optionally, by further steps, for further treatment of the dispersion obtained.

On account of its advantageous profile of properties, the dispersion according to the invention is suitable particularly for use in connection with the magnetic separation of mixtures, such as of ores, for example, which are obtained from naturally occurring deposits.

The present invention therefore also provides for the use of a dispersion according to the invention in the magnetic separation of mixtures.

Methods for the magnetic separation of mixtures, more particularly for separation of ores, are known per se to the skilled person and described in, for example, WO 2009/030669. In such methods, preferably, copper ores are separated from the gangue, which substantially comprises silicon dioxide.

Furthermore, on account of its advantageous profile of properties, the dispersion according to the invention is suitable particularly for use in paint formulations.

The present invention therefore also provides for the use of a dispersion according to the invention for producing paint formulations.

The present invention also provides a paint formulation comprising a dispersion according to the invention.

Paint formulations comprising dispersions of oxidic compounds are known per se to the skilled person and are described in, for example, EP 0 816 440 B1. Paints of the invention are, for example, those based on acrylic, alkyd, epoxy, phenolic, melamine, urea, polyester, polyurethane, isocyanate, benzoguanamine or cellulose ester resins. For preparing the paint formulations of the invention, a dispersion according to the invention is mixed with the stated high molecular mass materials, optionally with additives, such as extenders, other pigments, siccatives or plasticizers. Corresponding suitable additives and mixing techniques are known to the skilled person. The amount of a dispersion according to the invention is such that the magnetic iron oxides are present in the paint formulation in an amount of, for example, 0.5% to 40% by weight, based on the overall formulation.

The present invention also provides, furthermore, for the use of the dispersion according to the invention comprising magnetic particles for producing magnetic layers, for example for producing magnetic recording media.

Processes for producing a magnetic layer of this kind are known per se to the skilled person and are described in, for example, DE 39 14 565 C2. For this purpose, the dispersion according to the invention is used with customary binders, examples being copolymers of vinyl chloride, vinyl acetate, and vinyl alcohol, copolymers of vinylidene chloride and acrylonitrile, polyvinyl acetals such as polyvinyl formals, polyesters/polyurethanes, polyurethane elastomers or polyether elastomers, phenoxy resins or epoxy resins, and mixtures thereof. Application to suitable substrates exemplified by films of polyester, such as polyethylene terephthalate, polyolefins, such as polypropylene, cellulose derivatives such as triacetate, polycarbonates or rigid layer supports of nonmagnetic metals such as aluminum, or ceramic materials, takes place in accordance with techniques that are known to the skilled person, as for example by means of a reverse-roll coater, by halftone printing or extruder casting.

### EXAMPLES

### 1) Inventive Production of A Homogeneous Dispersion of Hydrophobized Magnetite Particles (Size: Ø=3-5 μm)

2 g of hydrophobized magnetite (magnetite pigment 345 from BASF SE) having a particle size of 3-5 μm ad being coated with octylphosphonic acid (20 molecules per nm²) are introduced into a mixture of 20 g of ethanol and 80 g of water with a paddle stirrer. The mixture is subsequently treated with the Ultraturrax (3000 rpm) for 2.5 minutes.

The dispersion thus produced is combined with a mixture of hydrophobized chalcopyrite (CuFeS₂) and unhydrophobized quartz sand (mass ratio 1:99), and the coupling of the chalcopyrite component to the hydrophobized magnetite is optimum, as shown by a subsequent magnetic separation (described in WO 2009/030669 A1, for example). Only with a magnetite dispersion produced in this way are optimum Cu removal rates demonstrated.

### 2) Inventive Production of A Homogeneous Dispersion of Hydrophobized Magnetite Particles (Primary Particle Size: Ø=0.3-0.4 μm)

3 g of hydrophobized magnetite (magnetic pigment Bayoxid E8706) coated with hydrolysis product of octyltrimethoxysilane, coating density around 15 molecules/nm²) are stirred to a paste with around 5 ml of isopropanol. The paste and also 95 ml of water are subsequently dispersed with 250 g of 2 mm ZrO₂ grinding media for 2 minutes in a vibration mill at around 400 rpm.

Optimum homogeneous dispersion of the magnetite is evidenced again by the combining of a mixture of hydrophobized chalcopyrite and unhydrophobized quartz sand and by optimum coupling of the chalcopyrite component to the hydrophobized magnetite, as shown by a subsequent magnetic separation (described in WO 2009/030669 A1, for example).

### 3) Comparative Example

3 g of hydrophobized magnetite (magnetic pigment Bayoxid E8706) coated with hydrolysis product of octyltrimethoxysilane (coating density around 15 molecules/nm²) are stirred in water without any further additives. The paste and also 95 ml of water are subsequently dispersed with 250 g of 2 mm ZrO₂ grinding media for 2 minutes in a vibration mill at around 400 rpm. In spite of the indicated introduction of shearing energy, hydrophobic agglomerates of hydrophobic magnetites are formed, with a size in the millimeter range, in water, and so only part of the hydrophobic surface is available for coupling of other hydrophobic materials.

1. A dispersion at least comprising:
(A) particles comprising at least one magnetic iron oxide as component A and
(B) a solvent mixture as component B, comprising
(B1) 5% to 95% by weight of at least one water-miscible organic solvent LM as component B1 and
(B2) 5% to 95% by weight of water as component B2,
the sum of components B1 and B2 making 100% by weight.

2. The dispersion according to claim 1, wherein components (A), (B), (B1), and (B2) are present in the following amounts:
(A) 1% to 95% by weight of particles comprising at least one magnetic iron oxide as component A,
(B) 5% to 99% by weight of at least one solvent mixture as component B, comprising
(B1) 5% to 95% by weight of at least one water-miscible organic solvent LM as component B1 and
(B2) 5% to 95% by weight of water,
the sum of components (B1) and (B2) making 100% by weight,
and the sum of components (A) and (B) making 100% by weight.

3. The dispersion according to claim 1 or 2, wherein the particles present as component A comprise at least one iron oxide selected from the group consisting of magnetite, maghemite, and mixtures thereof.

4. The dispersion according to any of claims 1 to 3, wherein said at least one water-miscible organic solvent (B1) is selected from the group consisting of monohydric alcohols, polyhydric alcohols, ethers, polyethers, and mixtures thereof.

5. The dispersion according to any of claims 1 to 4, wherein the particles comprising at least one magnetic iron oxide (A) are modified on the surface with at least one surface-active substance.

6. The dispersion according to any of claims 1 to 5, wherein the particles comprising at least one magnetic iron oxide have a diameter of 200 nm to 100 μm.

7. A method for producing a dispersion according to any of claims 1 to 6, comprising at least the following steps:
(I) mixing particles comprising at least one magnetic iron oxide with at least one water-miscible organic solvent LM and water, and
(II) homogenizing the mixture from step (I),
wherein a shearing energy of at least 2 kW/m³ is introduced into the mixture in step (II).

8. The method according to claim 7, wherein in step (I), first the particles are introduced and then a mixture comprising at least one water-miscible organic solvent and water is added.

9. The method according to claim 7, wherein, in step (I), first the particles are introduced, then a water-miscible organic solvent is added, and subsequently water is added.

10. The method according to claim 7, wherein, in step (I), first the particles are introduced, then water is added, and subsequently a water-miscible organic solvent is added.

11. The method according to any of claims 7 to 10, wherein the particles are treated before step (I) with at least one surface-active substance.

12. The use of a dispersion according to any of claims 1 to 6 in the magnetic separation of mixtures.

13. The use of a dispersion according to any of claims 1 to 6 for producing paint formulations.

14. A paint formulation comprising a dispersion according to any of claims 1 to 6.

15. The use of a dispersion according to any of claims 1 to 6 for producing magnetic layers.
